(19) United States
(12) Patent Application Publication
(10) Pub. No.: US 2011/0078165 A1
(43) Pub. Date: Mar. 31, 2011

(54) DOCUMENT-FRAGMENT TRANSCLUSION

(76) Inventors: Steven Battle, Bristol City (GB); Helen Balinsky, Cardiff Wales (GB)

(21) Appl. No.: 12/570,501

(22) Filed: Sep. 30, 2009

(51) Int. Cl. G06F 17/30

(52) U.S. Cl. 707/756; 707/E17.014; 707/795

(57) ABSTRACT

A transclusion method provides for transclude copying a source fragment of a source document into a target document. As a result, the target document contains a target fragment. The target fragment is a copy of the source fragment. A reference to the source document is included with the target fragment in the target document. The reference identifies a location for the source document and provides search data for locating the source fragment within the source document.

### BACKGROUND

Herein, related art is described for expository purposes. Related art labeled “prior art”, if any, is admitted prior art; related art not labeled “prior art” is not admitted prior art.

The Internet and, especially, the World Wide Web have made it easy to generate documents using fragments of web pages and other materials on the Internet. Recording the URL of the source document allows one to reference the source and to check for updates of the fragment. Navigational cues built into the source document can make it possible to access a fragment directly. If that fragment has been updated in the source document, the corresponding update can be made to the referencing document.

### BRIEF DESCRIPTION OF THE DRAWINGS

FIG. 1 is a schematic diagram of a network system including a client system and a server.

FIG. 2 is a schematic diagram of the client system of FIG. 1.

FIG. 3 is a flow chart of a transclusion generation portion of a method implemented by a browser of the client system of FIG. 2.

FIG. 4 is a flow chart of a transclusion update portion of the method of FIG. 3.

### DETAILED DESCRIPTION

When a user copies a fragment of a source document into a transcluding document, a transclusion-capable browser or other document handler generates search data from the fragment and, in some cases, its context within the source document. Herein, “transclusion” denotes inclusion with a reference back to the source. When the user requests retrieval or update of the fragment in the transcluding document, the browser uses the search data to locate the source fragment in the source document. The source fragment can be found this way: despite changes in the source document (e.g., insertion or deletion of material above the fragment) that caused the fragment to move; and despite edits to the fragment itself. This client-side solution provides robust retrieval without relying on special server-side capabilities or relying on the author of the source document to provide navigational markers for the fragment.

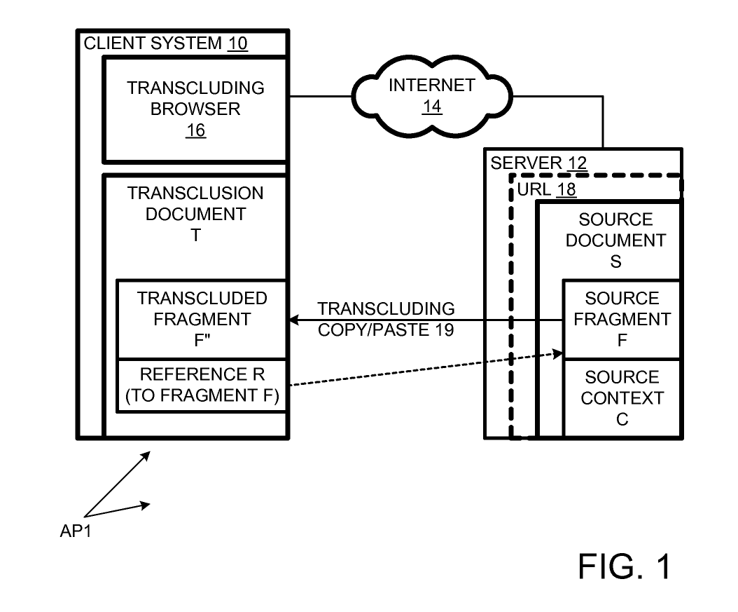

As shown in FIG. 1, network system AP1 includes a client system 10, a server system 12, and the Internet 14. Client system 10 includes a transcluding browser 16 and a local (i.e., on client system 10) transclusion document T, which includes a transcluded fragment F″ and a reference R, associated with fragment F″. In an alternative embodiment, a trancluding document handler other than a browser is employed. Server system 12 stores a remote (i.e., not on client system 10) source document S at an associated uniform resource location URL 18. Source document S includes a source fragment F and an associated source context C, e.g., a document structure within which fragment F sits.

Transcluded fragment F″ results from a transcluding copy-and paste operation 19 from source fragment F, so that the fragment F″ matches fragment F at the time of copy-and-paste operation 19. Reference R is stored as an attribute of fragment F″ in transclusion document T. Reference R is in the form of an URL with a data fragment. The referenced URL is URL 18, where source document S is stored. The data fragment is search data for locating (possibly updated) source fragment F within (possibly updated) source document S. System AP1 provides other methods for including a reference with a fragment, e.g., by directly entering the reference.

Client system 10 includes computer-readable storage media 20, processors 22, and communications devices (including input-output devices) 26. Media 20 is encoded with code 30, which defines transcluding browser 16, transclusion document T, and a temporary proxy document S′. In other words, processors 22 can execute code 30 to provide for functionalities of browser 16. Proxy document S′ functions as a local search copy of source document S.

Transclusion document T includes transcluded fragment F″, and reference R. Reference R includes a URL 32, corresponding to URL 18 of source document S. In addition, reference R includes a data fragment that includes search data 34. Search data 34 includes fragment data 36, e.g., some or all the contents of fragment F, and context data 38, e.g., describing structural relations between fragment F and nearby elements. In some instances, the search data can be an exact or near quote of the fragment and include or exclude context data.

Transcluding browser 16 enables a user of client system 10 to access server 12 (FIG. 1) and access source document S to that a local copy of document S can be had by client system 10. Browser 16 includes a search engine 40 for searching for a fragment within a document. If the local copy of an accessed document is not in a format suitable for searching by engine 40, a document converter 42 can convert the local copy to a searchable or more searchable version. For example, search engine 40 is designed to search for hierarchical (e.g., XML parent, child, and sibling) relationships between objects of a document. If a source document does not specify such hierarchical relationships, the local copy will not either, at least initially. However, before search engine 40 searches a local copy, document converter 42 converts the local copy to a searchable local copy such as proxy document S′.

For example, document S may be a portable document format (PDF) document that document converter 42 converts to XML with hierarchical relationships explicitly indicated by markups. In cases where the source document is in XML format with explicit hierarchical relationships, conversion can be omitted. In an alternative embodiment, the local proxy of the source document is not converted; instead, the search engine, in effect, does the conversion “on-the-fly”, as it searches a document for a fragment. In such a case, the fragment and a skeletal structure (of the entire document or just the structure close to the fragment) can be extracted without converting the entire document. Whether or not converter 42 actually converts a proxy, it extracts search criteria 44 for any fragment subject to a transcluding copy-and-paste operation 19 (FIG. 1).

Search engine 40 includes a URL parser 46; when a user requests retrieval of a source fragment, parser 46 separates the URL and search-data segments of the associated reference, e.g., reference R. The URL is used to access the source document from which the local searchable proxy, e.g., document S′ is made. Parser 46 also provides the search data, e.g., data 38, to be used in locating the requested fragment within the proxy document.

A match detector 48 is used to detect matches between search data 34 and fragments within a proxy document. In some cases, two or more possible matches may be found; in such a case, a match evaluator 50 of search engine 40 can indicate which candidate is a better match, e.g., which one has the smaller edit distance of the original fragment. Also, match evaluator 50 can indicate to a user whether or not the match is perfect (in which no update, for example, would be required) or whether some differences are detected. In evaluating matches, evaluator 50 can apply edit-distance metrics, e.g., determine a number of character or attribute differences between the best-matching proxy fragment F′ and the search data 34.

Edit differences can differ in importance. For example, a change in hierarchical relationship may be more important, from a search standpoint, than adding a missing character or italicizing a word. Accordingly, match evaluator 50 can refer to match weightings 52 (in the form of configuration data) for relative weightings of attribute changes or other edit events for weightings to be applied in determining edit distances and, thus, in evaluating fragments.

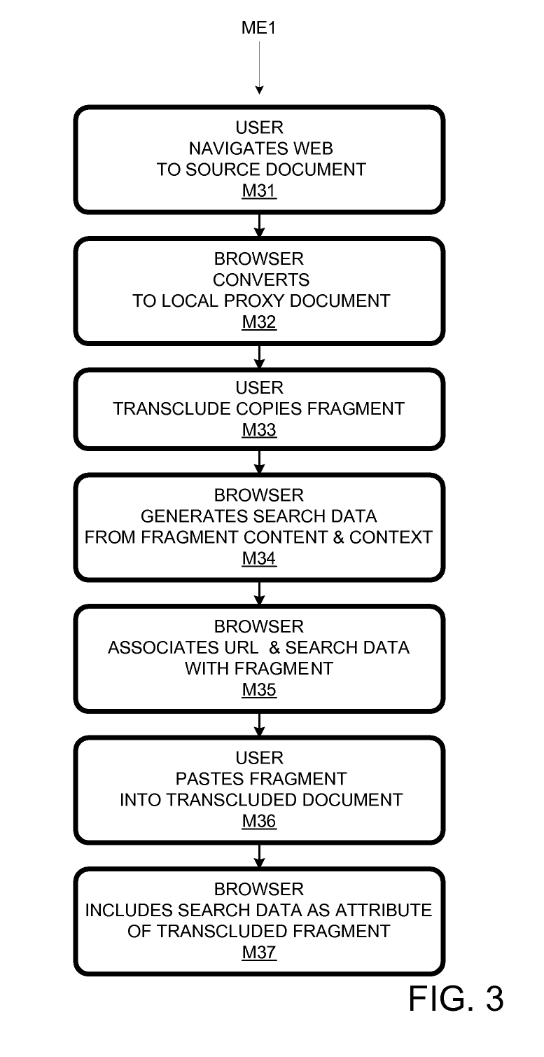

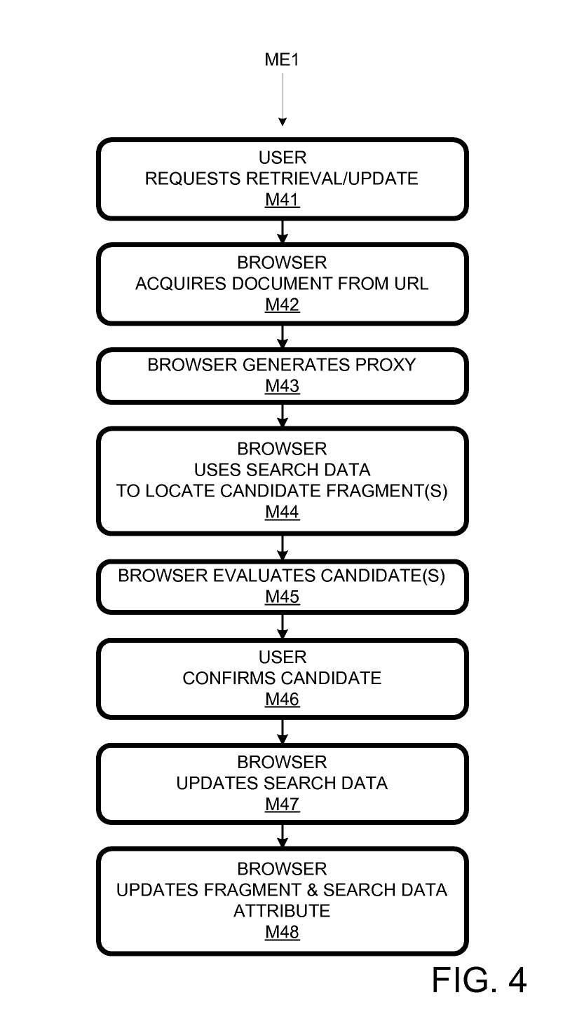

Browser 16 provides for implementing a method ME1, flow charted in FIGS. 3 and 4. The method segments of FIG. 3 collectively provide for creation of a transclusion, while the method segments of FIG. 4 collectively provide for a retrieval of a source fragment and an update of a transcluded fragment.

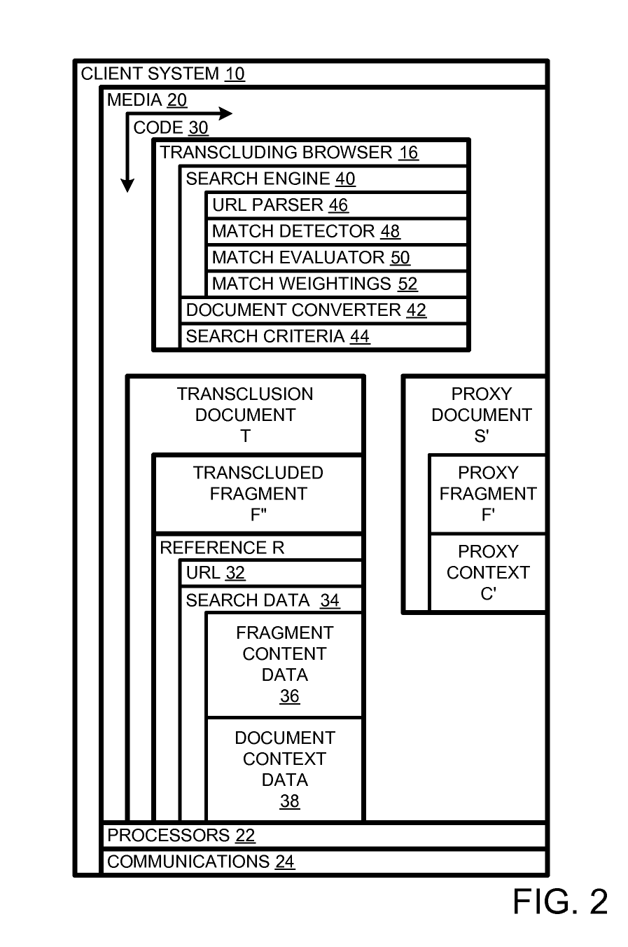

At method segment M31, a user of client system 10 uses browser 16 to navigate the Internet and World-Wide Web to access a source document such as document S, FIG. 1. To this end, the user can type in URL 18 (FIG. 1). Alternatively, the user can right-click on transcluded fragment F″ (FIGS. 1 and 2), to access a pop-up menu and select “retrieve” or “update”. Other methods of accessing a document on the Internet can be used as is know in the art. Also, access to source documents can be had over a local-area network (LAN), wide-area network (WAN), or cellular network, without accessing the Internet.

At method segment M32, document converter 42 of browser 16 converts all or part of the accessed document to a searchable format unless the source document is already in a searchable format. A conversion can involve an actual change of format, e.g., from PDF to XML, or merely involve an annotation of an existing XML or other document or generating meta-data reflecting the document structure. In any event, a searchable local proxy document, e.g., document S′, results.

At method segment M33, the user “transclude” copies the fragment. In browser 16, copy operations are transclude copy operations by default. Alternatively, a transclude copy operation, distinct from a regular copy operation, can be selected depending on whether the user wants a reference back to the source. In some embodiments, method segment M32 is omitted or delayed until a transclude copy operation is begun, avoiding conversion of documents that are only read.

At method segment M34, document converter 42 of browser 16 generates or extracts search data, e.g., search data 34 (FIG. 2) from the proxy search fragment, including fragment content data 36 from fragment F′ (FIG. 2) and document context data 38 from context C′. This can involve selecting an extended section including the proxy fragment and enough surrounding structure to disambiguate the proxy fragment. In some embodiments in which method segment M32 is omitted, method segment M34 can involve inferring context data from the fragment and its context (which can be less than the whole document). At method segment M35, browser 16 associates the URL of the source document and the search data from method segment M34 with the fragment, e.g., fragment F′.

At method segment M36, the user pastes the fragment into the target document, e.g., transcluded document T. In response, browser 16 generates the corresponding transcluded fragment, e.g., fragment F″ in the target document. In addition, a reference including the source document URL and the search data from method segment M34, e.g., reference R, is associated with fragment F″ as an attribute. This completes creation of a transclusion.

At method segment M41, FIG. 4, the user requests retrieval and/or update of a transcluded fragment. For example, a user can click on fragment F″ (FIG. 2) and select “Update” from a pop-up menu. In response, at method segment M42, browser 16 acquires (a copy of) the source document at the URL specified by the respective reference attribute (reference R) of the transcluded fragment F″. At method segment M43, document converter 42 of browser 16 generates a searchable proxy such as proxy document S′.

At method segment M44, search engine 40 of browser 16 searches the proxy document for best match to the search data of the fragment reference. At method segment M45, match evaluator 50 evaluates detected matches to find a best match, if there is more than one candidate match, and to alert a user to possible changes in the source fragment. At method segment M46, browser 16 presents the best candidate fragment to the user, who may confirm the candidate as a replacement as an update to the previous version of the transcluded fragment. If the edit distance is zero, then the source fragment has not been updated and the update of the target fragment can be omitted. If the transcluded fragment is updated, then the associated search data can be updated as well, at method segment M47. In that case, browser 16 updates the transcluded document with the new version of the source fragment and new search data at method segment M48.

The use of search data to locate a fragment instead of, for example, a character offset within a document, provides for transclusion that is “robust” in the sense it is not sensitive to minor to moderate edits of a source document. The search data can include the entire fragment or just parts of the fragment (enough to identify the beginning and end of the fragment). In addition, the search data can include context data, e.g., specify attributes or indicate whether the fragment is a parent, child, or sibling of a preceding fragment or a succeeding fragment.

At the point of creation, the user has selected a source document and a particular subsection of that document. For example, to record the quote, “the inclusion of part of a document into another by reference” from Wikipedia's entry on transclusion, one could use the URL below (in which “/” is changed to “|” so that the URL is not browser executable). The data itself is URL encoded to observe URL syntax rules:

http:∥en.wikipedia.org|wiki|Transclusion#data:the+inclusion+of+part+of+a+document+into+another+by+reference

To encompass additional outlying content we must take the document structure into account. In general, there will be an equivalence between the logical document structure and the XML markup. When the selection of the source material is made, the surrounding context is analyzed to extract the markup structure. The markup structure in which the selected quote is embedded can be identified; the markup structure can include the structure pertaining to its siblings. In each case, the number of levels of containing/surrounding markup can be limited, e.g., just enough to disambiguate the selection, even if that means there is no complete path back to the root of the document. The following data fragment provides an example of this approach combining content and markup (in the following examples XML style angle brackets have been replaced by square brackets and slashes have been replaced by vertical lines):

data[p]*[b]transclusion[/b]*{the+inclusion+of+part+of+a+docum ent+into+another+by+reference*}[/p]

This data fragment is able to consume characters (matching the ‘*’ wild-card) right up to the end of the paragraph explicitly denoted by “[/p]”. It solves the problem of including outlying content added to the end of a logical section. For example, this data fragment now matches the paragraph quoted from Wikipedia, “the inclusion of part of a document into another document by reference. It is a feature of substitution templates.”

In this example, the quote is embedded within a paragraph and is preceded by a sibling heading in bold. The asterisks are wild-card symbols allowing the match detector to ignore content without penalty (matching characters are not tallied into the edit distance). XML markup is typically not subject to editing in the same way that the content is because the vocabulary of the XML language is more or less fixed. This approach is markup-sensitive in that XML tags are treated as indivisible symbols for the purpose of calculating edit distance. The braces (‘{’ & ‘}’) mark the beginning and end of the desired selection, distinguishing it from the surrounding context. The character codes used here (asterisks and braces) are merely for illustrative purposes and may be replaced by alternative escaped characters without confusion.

The matching process can be made more robust by canonicalization of the document structure and corresponding markup. Important features of the document may be apparent in the visual appearance of the document, but not so clear in the markup. The canonicalization process involves a change in the representation of the document structure so that this implicit structure is evident in the markup.

In the example above, the ‘transclusion’ heading is represented in the original document by a section of bold text. The fact that this really denotes a heading can be brought out by analysis of the document. The formerly implicit heading semantics is made explicit in the resulting canonical representation (where a heading is denoted by an ‘h’ tag).

data[p]*transclusion[/h]*{the+inclusion+of+part+of+a+docum ent+into+another+by+reference*}[/p]

The idea of identifying implicit structure may be extended to include the extraction of structure from documents where the structure is entirely implicit. i.e., from non-XML document types where it is possible to generate a marked-up equivalent in a pre-processing stage.

If the referenced page is owned by a third party, whether or not it changes is typically outside the user's control. The transclusion must be robust in two senses: if the source changes, or even disappears, the content in the data fragment can be directly quoted; alternatively, to keep the quote up-to-date, the best match of the transclusion fragment to the revised source page can be identified. In accordance with HTTP, the data fragment is not sent to the server; the server is sent the main part of the URL without the fragment to be resolved as normal. All processing of the data fragment is performed by the client.

The author can refresh the document by automatically looking up the source material. In the simplest case, the URL is not resolved and the data fragment is quoted as-is in the document (that contains the reference). Alternatively, the main part of the URL is resolved as normal and the server returns a representation of the entire resource. The data fragment is matched to this representation to find the best match. This is based on minimizing the edit-distance between the data fragment and the representation. The comparison is asymmetric because we are looking for a substring within the source document, but preferably not within the data fragment. The substring closest to the data fragment is obtained. For example, if the Wikipedia entry is edited by the insertion of the word ‘document’ to read, “the inclusion of part of a document into another document by reference”, the previous data fragment still matches this substring but with a greater edit distance (9 characters).

Where the data fragment includes contextual markup, the retrieval process is markup sensitive. As described above, for the purposes of matching, markup tags are treated as a single unit. By default a mismatched tag incurs a penalty of 1 edit. This may be multiplied by a markup specific weighting factor. These weighting factors would be represented as additional metadata about the transclusion.

The data fragment may be subsequently updated to reflect any changes. This prevents the data fragment drifting further and further apart from the source material, tracking any changes. This is much the same as the creation of the original transclusion, but this time we update an existing transclusion, replacing the data fragment with one that reflects the most recent changes to the content. For example, take the original transclusion to be the following URL (with “/” changed to “|”) and data fragment:

http:∥en.wikipedia.org|wiki|Transclusion#data:the+inclusion+of+part+of+a+document+into+another+by+reference

The subsequently retrieved text indicates a change (a 9-character difference) from the original; the insertion of the word ‘document’, as in “the inclusion of part of a document into another document by reference”.

The existing transclusion is updated to reflect this difference, reapplying the process of creation, to become:

http:∥en.wikipedia.org|wiki|Transclusion#data:the+inclusion+of+part+of+a+document+into+another+by+reference

The updated transclusion now matches the retrieved text exactly.

Unlike other approaches that support transclusion references with respect to a fixed version of a document, this solution is designed to work with such changes, even where the user neither has control of the transcluded page, nor knowledge of how it might change. This solution is robust to changes as would be expected if the content was sourced from web-based collaborative tools such as wikis, allowing the content to be refreshed.

The intended usage of data fragment URLs is not within browsers but in metadata stored with documents enabling the content to be refreshed when the source material changes. The data fragment URLs are relatively straightforward and should be able to be constructed automatically in a select, copy-and-paste operation that takes into account not only the selection but the surrounding context.

Herein a “system” is any set of interacting elements. A system can be a physical machine having interacting components, a physical structure having elements that interact to main the structure, or physical media encoded with code defining interacting elements. “Transclude”, as used herein, means “include with a reference back to the source”. The foregoing and other variations upon and modifications to the illustrated embodiments are provided within the scope of some the following claims.

What is claimed is:

1. A transclusion method comprising:
transclude-copying a source fragment of a source document into a target document so that said target document contains a target fragment that is a copy of said source fragment; and
including in said target document in association with said target fragment, a reference to said source fragment, said reference identifying a location of said target document and search data to be used to locate said source fragment within said source document.

2. A transclusion method as recited in claim 1 wherein said location of said target document is specified by a URL and said search data includes context data regarding data not in said source fragment but in a context for said fragment in said source document.

3. A transclusion method as recited in claim 2 wherein said context data specifies hierarchical relations between said source fragment and elements of said context.

4. A transclusion method as recited in claim 1 further comprising converting said source document into a searchable local proxy document, said copying involving copying a proxy of said source fragment in said proxy document to said target document.

5. A transclusion method as recited in claim 1 wherein said including involves storing said reference as an attribute of said target fragment.

6. A transclusion method as recited in claim 1 further comprising:
a user acting on said target document so as to request retrieval of said source fragment or update of said target fragment or both; and
said browser using said reference to locate a current version of said source fragment and displaying it to said user or updating said target fragment so that it matches said current version of said source fragment.

7. A transclusion method as recited in claim 6 further comprising generating a current proxy version of said source document and providing a current proxy version of said source fragment for presentation to said user.

8. A transclusion method as recited in claim 6 further comprising:
generating a current version of said search data corresponding to a current version of said source fragment; and
including that current version of said search data in said target document in association with an updated version of said target fragment in said target document.

9. A transclusion method comprising:
selecting a transcluded target fragment of a target document stored on a client system;
requesting retrieval of a source fragment for said target document;
accessing a source document using a location identifier associated with a remote server stored in said target document in association with said target fragment;
generating a proxy document for said source document on said client system; and
using search data stored in said target document in association with said target fragment to locate a proxy fragment of said source fragment in said proxy for said source document.

10. A transclusion method as recited in claim 9 further comprising:
generating updated search data for said source fragment from said proxy document; and
associating said updated search data with a copy of said proxy document in said target document.

11. A system comprising hardware and software collectively providing:
a browser for providing for a user copying-and-pasting a source fragment of a source document into a target document so as to transclude a target fragment into said target document, said browser also providing for including in said target document a reference to said source fragment, said reference including a URL of said source document and search data for locating said source fragment in said source document; and
a document converter for extracting search data from said source document, said search data including data derived from said source fragment.

12. A system as recited in claim 11 wherein said document converter provides for generating a local proxy document for said source document and for storing said proxy document on said client system, said source document not being stored on said client system, said document converter generating said search data directly from said proxy document and indirectly from said source document.

13. A system as recited in claim 12 wherein said hardware and software further collectively provide a search engine, said proxy document differing in format from said source document so that said proxy document can be searched by said search engine.

14. A system as recited in claim 11 wherein said hardware and software further provide a search engine for finding an updated version of said source fragment by using said search data to search a proxy document of said source document.

15. A system as recited in claim 14 wherein said search engine includes a match evaluator for determining an edit distance between said target fragment and said updated version of said source fragment.

16. A system comprising computer-readable media encoded with code defining:
a browser for providing for a user copying-and-pasting a source fragment of a source document into a target document so as to transclude a target fragment in said target document, said browser also providing for including in said target document a reference to said source fragment, said reference including a URL of said source document and search data for locating said source fragment in said source document; and
a document converter for extracting search data from said source document, said search data including data derived from said source fragment.

17. A system as recited in claim 16 wherein said document converter provides for generating a local proxy document for said source document and for storing said proxy document on said client system, said source document not being stored on said client system, said document converter generating said search data directly from said proxy document and indirectly from said source document.

18. A system as recited in claim 17 wherein said code further defines a search engine, said proxy document differing in format from said source document so that said proxy document can be searched by said search engine.

19. A system as recited in claim 16 wherein said code further defines a search engine for finding an updated version of said source fragment by using said search data to search a proxy document of said source document.

20. A system as recited in claim 19 wherein said search engine includes a match evaluator for determining an edit distance between said target fragment and said updated version of said source fragment.
